(19) United States
(12) Patent Application Publication
(10) Pub. No.: US 2012/0289733 A1
(43) Pub. Date: Nov. 15, 2012

(54) NOVEL BORATE DERIVATIVES AND THEIR APPLICATIONS

(75) Inventors: Glenn L. HEISE, Britton, MI (US); Malgorzata Myslinska, Adrian, MI (US)

(73) Assignee: Anderson Development Company, Adrian, MI (US)

(21) Appl. No.: 13/469,544

(22) Filed: May 11, 2012

Related U.S. Application Data
(60) Provisional application No. 61/484,734, filed on May 11, 2011.

(51) Int. Cl. C07F 5/02; C07F 5/04

(52) U.S. Cl. 558/288; 558/294

(57) ABSTRACT

Borates, compositions comprising chiral (cyclic and acyclic) and achiral (cyclic and acyclic) borates; chiral (cyclic and acyclic) and achiral (cyclic and acyclic) biborates; and methods for their synthesis. Additionally, a significantly improved synthetic protocol for the synthesis of wide range of boronates starting from borates or biborates and Grignard or organolithium reagents that can be used for kilo lab and commercial scale production.

### CROSS REFERENCE TO RELATED APPLICATIONS

The present application claims the benefit of U.S. Provisional No. 61/484,734, filed on May 11, 2011 The entire contents of U.S. Provisional No. 61/484,734 are hereby incorporated herein by reference.

### TECHNICAL FIELD

1) Embodiments of the disclosure relate to borates, compositions comprising chiral (cyclic and acyclic) and achiral (cyclic and acyclic) borates; chiral (cyclic and acyclic) and achiral (cyclic and acyclic) biborates; and methods for their synthesis.

2) Additionally, embodiments of the disclosure provide a significantly improved synthetic protocol for the synthesis of wide range of boronates starting from borates or biborates and Grignard or organolithium reagents that can be used for kilo lab and commercial scale production.

### BACKGROUND

Organoboron compounds have been a topic of research for over 100 years. However the recent introduction of the Suzuki coupling increased dramatically the level of interest in more stable organoboron compounds such as boronic acids and boronic acid esters. Miayaura, N.; Suzuki, A. Chem. Rev. 1995, 95, 2457. Classical routes for the preparations of boronic acids involve utilization of Grignard- or lithiated reagents with trialkyl borates. Hall, D. G., Boronic Acids, Wiley: New York, 2005. In many cases the Grignard reagents are preferred due to their availability, intrinsic stability, and in general lower cost. In contrast, organolithium reagents can provide access to unique organoboronic acids which cannot be accessed via the Grignard route. Nevertheless the use of trialkyl borates and organometallic reagents usually require utilization of cryogenic technologies which make the processes ultimately less economically feasible especially, at larger scales. Besides the economics of the synthetic methods, the purity of the product plays an important role as well. Organoboronic acids are usually harder to purify than corresponding boronic acid esters or trifluoroborates. Most boronic acids exists as crystalline solids, however, their stoichiometry can be hard to determine due to formation of oligomeric anhydrides such as the trimeric boroxines. Formation of these polymeric and or cyclic species often makes their characterization and analysis very problematic. Additionally, exposure to air of dry samples of boronic acids usually leads to their rapid decomposition and resulting in the formation of boroxines, which are known to initiate the autooxidation processes. These stability concerns have led to the constantly increasing popularity of boronic acids esters as substitutes for boronic acids. The boronic acid esters are less polar and easier to handle due to the hydroxyl groups being masked. The ester moiety serves as a protecting group which at the same time alleviates the reactivity of the boron-carbon bond and makes the ester more thermodynamically stable. The most common way to prepare boronates is by the esterification reaction of the pre-isolated boronic acid with the alcohols or diols. There also exists a possibility to trans-esterify smaller dialkyl esters like the methyl ester with bulkier alcohols or 1,2-diols. However this is not the most practical and atom efficient approach. Usually cyclic boronic acid esters are prepared from the more air-sensitive or less stable boronic acids and 1,2-diols, such as catechol or pinacol, as they exhibit slower rates of proto-deboronation when compared to the corresponding boronic acids. Another recently developed and now frequently utilized approach involves direct in situ synthesis from the Grignard or organolithium reagents via a non-aqueous workup procedure. This is a very convenient method especially for unstable boronic acids because it does not require isolation and characterization of the boronic acid. Wong, K.-T.; Chien, Y.-Y.; Liao, Y.-L.; Lin, C.-C.; Chou, M.-Y.; Lueng, M.-K. J. Org. Chem. 2002, 67, 1041-1044. An alternative route, however highly expensive, involves transition metal catalysis with appropriate tetraalkoxydiboron or dialkoxyborane reagents such as bis(pinacolato)diboron or corresponding pinacolborane. Ito, S.; Terazono, T.; Kubo, T.; Okujima, T.; Morita, N.; Murafuji, T.; Sugihara, Y.; Fujimori, K.; Kawakami, J.; Tajiri, A., Tetrahedron, 2004, 60, 5357-5366. These reagents are presently commercially available which makes their applications prevalent in the literature. As a result of these processes boronic acid pinacol esters are obtained. They are hydrolytically the most stable and very robust amongst similar boronates. It is worth mentioning however, that they are extremely hard to hydrolyze to their corresponding boronic acid derivatives. Typically sodium periodide is utilized in the hydrolysis of boronic acid pinacol esters. It is also known that 2-isopropoxy-4,4,5,5-tetramethyl-1,3,2-dioxaborolane can be used directly in the synthesis of pinacol boronates starting with an organolithium reagent, as was demonstrated by Stoltz in the first total synthesis of Dragmacidin D. Garg, N. K.; Sarpong, R.; Stoltz, B. M., J. Am. Chem. Soc. 2002, 124, 13179-13184. The reaction generally provides a good yield of the desired pinacol boronate unless there are steric effects involved due to the bulkiness of the pinacol moiety. It has been also reported that the process requires cryogenic conditions, typically −78° C. Wallace, R. H.; Zong, K. K., Tetrahedron Lett. 1992, 33, 6941-6944; Greene, T. W., Protective Groups in Organic Synthesis, 4th Edition, John Wiley & Sons, New York, 2006. Taking into account the above limitations along with the relatively high price of pinacol, the application of these derivatives in commercial manufacturing initiatives can be very costly. Nevertheless there is an increasing trend and need in the use of cyclic boronates in Suzuki coupling reactions as well as in other synthetically useful transformations.

### DESCRIPTION

Embodiments of the disclosure relate to borates, compositions comprising chiral (cyclic and acyclic) and achiral (cyclic and acyclic) borates, chiral (cyclic and acyclic) and achiral (cyclic and acyclic) biborates; and methods for their synthesis.

Embodiments of the disclosure include compounds I and II of the formulas shown in Scheme 1. Additionally their applications are described.

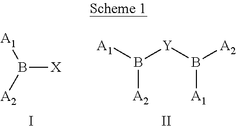

In an aspect, the A₁ and A₂ are independently selected from the group consisting of N—R, O—R, P—R and Si—R where R is selected independently from group consisting of optionally substituted alkyl, cycloalkyl, heterocycloalkyl, allyl, vinyl, aryl, benzyl, alkynyl, alkenyl, heteroaryl, trifluoromethyl, fluoroalkyl, acyl, amido and carboxyl.

The term “optionally substituted” means that one or more hydrogen atoms (up to the maximum number available) of a particular chemical structure are replaced by any group know in the art. The substitution provides chemically feasible and stable molecules.

In another aspect, A₁ and A₂ can be joined together to form a carbocyclic, bicyclic, heterocyclic, aromatic or heteroaromatic ring with one or more R substituents where R is selected independently from the group defined above.

In another aspect, A₁ and A₂ can be joined to form a diol of the formula OH—R₁—R₂—OH, diamine of the formula RN—R₁—R₂—NR, or aminoalcohol of the formula RN—R₁—R₂—OH, where R₁ and R₂ may be selected from the above description of R. For example, embodiments of the diol, diamine or aminoalcohol can include, structurally, 1,2-diols, 1,3-diols, 2,3-diols, 1,4-diols, 3,4-diols, 2,4-diols, 2,5-diols, 1,5-diols, 1,6-diols, 2,5-diols, 1,2-diamines, 1,3-diamines, 2,3-diamines, 1,4-diamines, 3,4-diamines, 2,4-diamines, 2,5-diamines, 1,5-diamines, 1,6-diamines, 2,5-diamines; 1,2-aminoalcohols, 1,3-aminoalcohols, 2,3-aminoalcohols, 1,4-aminoalcohols, 3,4-aminoalcohols, 2,4-aminoalcohols, 2,5-aminoalcohols, 1,5-aminoalcohols, 1,6-aminoalcohols, 2,5-aminoalcohols.

In another aspect of the invention, A₁ and A₂ can be joined together and represent chiral bidentate ligands, for example, those having diastereomeric and/or enantiomeric purity. Exemplary chiral bidentate ligands include those that are derived from optionally protected carbohydrates, aminoalcohols, amino acids, alkaloids, aromatic or alkyl alcohols, aromatic or alkyl amines, diamines, diols, biaryl alcohols, biaryl amines, D- or L-tartaric acid or combinations thereof, and others known in art that are capable of forming chiral boron structures.

The skilled artisan will recognize that such chiral boron structures may exist in oligomeric form. Chiral diols used as chiral auxiliaries are well known in the art. Useful monodentate and bidentate chiral ligands are those that are derived from optionally protected carbohydrates, amino acids, amino alcohols, alkaloids, chiral aromatic or alkyl alcohols, chiral aromatic or alkyl amines, chiral diamines, chiral diols, chiral biaryl alcohols, chiral biaryl amines, D- or L-tartaric acid or combinations thereof, and are capable of forming chiral boron esters or boronates. By “protected” it is meant that the chiral or nonchiral structures such as carbohydrates, amino acids, amino alcohols, alkaloids, chiral aromatic or alkyl alcohols, chiral aromatic or alkyl amines, diamines, diols, biaryl alcohols, biaryl amines, D- or L-tartaric acid or combinations thereof, comprise protecting groups including, but not limited to, ketals, trimethylsilyl ethers, tetrahydropyranyl ethers, triphenylmethyl ethers, benzyl ethers, etc. Such chiral structures (ligands) have one or more chiral centers and are optically active. Some examples of these chiral ligands include but are not limited to 1,2:5,6-Di-O-isopropylidene-D-mannitol (“DIPM”); 3,5:4,6-Di-O-ethylidene-D-glucitol (“DES”); S-BINOL; (S)-1-tert-Butylamino-2,3-propanediol (“(S)-PROP”); 1,2:5,6-Di-O-cyclohexylidene-α-D-glucofuranose (“DCG”); 3-O-Benzyl-1,2:5,6-di-O-cyclohexylidene-α-D-glucofuranose (“BDCG”); 3-O-Benzyl-1,2-β-cyclohexylidene-α-D-glucofuranose (“BCC”); 2-O-Benzyl-3,5:4,6-diethylidene-D-glucidol (“BDC”); 1,3:4,6-Di-O-benzyliden-D-mannitol (“DBM”); (S,S)-1,3-Bis-(1-phenylethylamino)-2-propanol (“(S,S)-BPAP”); (S)-N-isobutyl-α-phenylethylamine (“(S)-IBPA”); (R)-N-isobutyl-α-phenylethylamine (“(R)-IBPA”); (S,S)-N,N-Bis(methylbenzyl)ethylenediamine (“(S,S)-BMBE”); 1,2-O-isopropylidene-α-D-xylofuranose (“1×F”); (R)-1-tert-Butylamino-2,3-propanediol (“BAP”); 1,2-O-Cyclohexylidene-α-D-xylofuranose (“CXF”); (S)-Phenylalaminol (“(S)-PA”); (S)-N,N-(Dimethyl)phenylalaminol (“(S)-DMPA”); (3S,4S)-1-Benzyl-3,4-dihydroxypyrrolidine (“BDHP”); 1-O-Triphenylmethyl-3,5:4,6-di-O-ethylidene-D-glucitol (“TDG”); 1,3:4,6-Di-O-(p-anisylidene)-D-mannitol (“DAM”); 1,3:4,6-Di-O-(p-toluoylidene)-D-mannitol (“DTM1”); 2,3-O-Cyclohexylidene-1,1,4,4-tetraphenyl-L-threitol (“CYTOL”); Di-O-cyclohexylidene-D-allofuranose (“DCAF”); Di-O-isopropylidene-D-allofuranose (“DIPAF”); 2,3:4,6-Di-O-isopropylidene-L-sorbofuranose (“DIPS”); (+)-trans-α,α′-(2,2-Dimethyl-1,3-dioxolane-4,5-diyl)bis(diphenylmethanol) (“(+)-DDM”); (−)-trans-α,α′-(2,2-Dimethyl-1,3-dioxolane-4,5-diyl)bis(diphenylmethanol) (“(−)-DDM”); (−)-8-methoxy-trans-p-menth-3-ol (“MTM”); 1,2:3,5-Di-O-benzylidene-D-glucofuranose (“DBGLU”); L-(−)-2,4:3,5-Di-O-methylidene-D-xylitol (“L-DMX”); D-(+)-2,4:3,5-Di-O-methylidene-D-xylitol (“D-DMX”); (S)-(−)-α,α-diphenyl-(1,2,3,4-tetrahydroisoquinolin-3-yl)-methanol (“DTM2”); (1R,2S)-(−)-ephedrine (“Eph”); 1,6-anhydro-β-D-glucose (“AG”); (S)-α-phenethylamine (“(S)-PEA); (S)-(−)-α,α-diphenyl-2-pyrrolidinemethanol (“DPP”); (1S,2S,3R,5R)-(+)-pinanediol (“(+)-PDOL”); (S)-2-(anilinomethyl)pyrrolidine (“AMP”); and (4R,5R)-2,2-dimethyl-α,α,α′,α′-tetra-(2-naphthyl)-dioxolane-4,5-dimethanol (“β-DND”). The abbreviations of these ligands will be used to facilitate reading of this specification.

In some aspects of this invention, exemplary embodiments of chiral bidentate ligands may contain a C₂ axis of symmetry. By “C₂ axis of symmetry” is meant a molecule having a C₂ axis as the sole element of symmetry, and therefore not possessing reflection symmetry (no sigma plane). The chiral ligands can also be described as “axially dissymmetric.” Where the chiral boron structure of embodiments of the disclosure comprise A₁, A₂, and X or Y, it is understood that the structures may contain one to three chiral ligands as well as one to two achiral ligands in the same structure or a structure can comprise a mixture of up to three different chiral ligands.

In another aspect, A₁ and A₂ can be joined to form a chiral diol of the formula OH—R₁—R₂—OH, chiral diamine of the formula RN—R₁—R₂—NR, or chiral aminoalcohol of the formula RN—R₁—R₂—OH, for example, having diastereomeric and/or enantiomeric purity. Where R₁ and R₂ may be selected from the above description of R. For example, embodiments of the chiral diol, chiral diamine, or chiral aminoalcohol can include, structurally, 1,2-diols, 1,3-diols, 2,3-diols, 1,4-diols, 3,4-diols, 2,4-diols, 2,5-diols, 1,5-diols, 1,6-diols, 2,5-diols, 1,2-diamines, 1,3-diamines, 2,3-diamines, 1,4-diamines, 3,4-diamines, 2,4-diamines, 2,5-diamines, 1,5-diamines, 1,6-diamines, 2,5-diamines; 1,2-aminoalcohols, 1,3-aminoalcohols, 2,3-aminoalcohols, 1,4-aminoalcohols, 3,4-aminoalcohols, 2,4-aminoalcohols, 2,5-aminoalcohols, 1,5-aminoalcohols, 1,6-aminoalcohols, 2,5-aminoalcohols.

Y can be independently selected from the group consisting N—R—N, O—R—O, P—R—P, Si—R—Si; where R is selected from the group defined above. Y may be a chiral moiety. For example, Y may be a chiral moiety within an embodiment where both A₁ and A₂ are achiral ligands.

X can be independently selected from the group consisting of O—R, N—R, P—R, Si—R where R is selected from the group defined above. X may be a chiral moiety. For example, X may be a chiral moiety within an embodiment where both A₁ and A₂ are achiral ligands.

The terms alkyl, alkenyl and alkynyl refer to a branched or non-branched chain having from 1 to 20 carbons which can be optionally substituted with R defined above.

The term aryl refers to aromatic moiety comprising one to three rings which can be optionally substituted. It can be used when an aromatic ring is fused to one or more non-aromatic rings.

The term heteroaromatic or heteroaryl refers to an aromatic moiety (6, 10 or 14π electrons shared in cyclic array) with at least one heteroatom (other than carbon) in the ring that can be optionally substituted. It can be used when a heteroaromatic ring is fused to one or more non-aromatic rings.

The term cycloalkyl refers to a 3-, 4-, 5-, 6-, 7-, 8-, 9-, 10-member ring structure saturated or partially unsaturated that can be optionally substituted.

The term heterocycloalkyl refers to a 3-, 4-, 5-, 6-, 7-, 8-, 9-, 10-member ring structure containing at least one heteroatom (atom different than carbon) in the skeleton that can be optionally substituted.

In another aspect, the disclosure includes embodiments directed to a synthetic protocol for the synthesis of wide range of boronates starting from Grignard or organolithium reagents as shown in the Scheme 2.

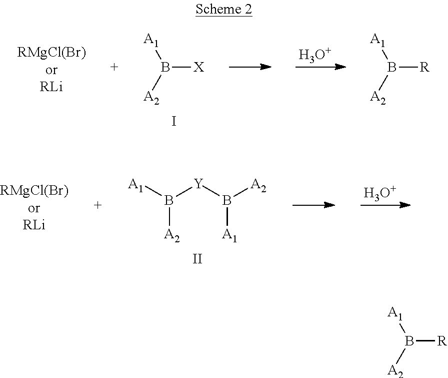

The previously disclosed compounds I and II may be used in the process Scheme 2 shown. The process to form the corresponding boronates of compounds I and II can be performed sequentially in a single process vessel. Further, any borate of the general formulas of I and II, but without limit to previous descriptions as to the nature of A₁, A₂, X or Y may be used in the synthesis protocols of Scheme 2.

Exemplary Grignard reagents include compounds of the formula of RMgCl(Br)(I) wherein R is selected independently from group consisting of optionally substituted alkyl, cycloalkyl, heterocycloalkyl, allyl, vinyl, aryl, benzyl, alkynyl, alkenyl, heteroaryl, trifluoromethyl, fluoroalky.

Exemplary organolithium reagents include compounds of the formula of RLi wherein R is selected independently from group consisting of optionally substituted alkyl, cycloalkyl, heterocycloalkyl, allyl, vinyl, aryl, benzyl, alkynyl, alkenyl, heteroaryl, trifluoromethyl, fluoroalkyl.

Embodiments of the disclosure include using borate in a molar ratio range from 1:1 to 2:1 compared to the amount of Grignard or organolithium reagent. Embodiments of the disclosure include using biborate in a molar ratio range from 1:2 to 1:1 compared to the amount of Grignard or organolithium reagent.

Embodiments of the synthesis protocols of Scheme 2 offer different process conditions not practiced at the present time. For example, embodiments of the synthesis protocols of Scheme 2 may be operated in the temperature range of 10-28° C., or ambient temperatures. The ability to operate at a temperature range of 10-28° C. is a huge improvement compared to the cryogenic temperatures typically used for the synthesis of boronates. As a result the need for specialized cooling capabilities will no longer be needed thus leading to significant reduction in costs and cycle time and improvements in product yield.

An exemplary medium for the synthesis of Scheme 2 includes polar and aprotic solvents, which include, but are not limited to: diethyl ether, tetrahydrofuran, dioxane and other ethers known in the art. A mixture (in any ratio) of any nonpolar and aprotic solvent with polar and aprotic solvent can be utilized as well. Examples include but are not limited to: cyclohexane:tetrahydrofuran, toluene:tetrahydrofuran etc. The reaction can be quenched in situ with aqueous solution of inorganic or organic acid or aqueous solution of ammonium chloride at temperatures-10° C.-15° C. Other aqueous solutions of inorganic or organic salts can be utilized as well as long as the ph of the particular solutions is slightly acidic.

In an embodiment, any concentration of medium may be used, for example the concentration of the reaction may not be limited by any weight or volumetric ratio (solvent:reagents). For example, the amount of medium may be limited to keep the reagents concentrated. In another example, the amount of medium may be increased to control the reaction of the reagents. In an embodiment to which this disclosure is not limited, a 1 mol/L solution may be used.

### EXAMPLES

Most of the solvents and reagents were purchased from commercial sources and used without further purification. THF was dried using 4 Å molecular sieves overnight before use. All NMR spectra (1H, 13C and 11B) were recorded on a Varian Mercury 400 MHz Spectrometer at 400, 100.6 and 128.3 MHz respectively. 11B NMR spectra were performed using BF3.Et2O as an external standard. All reactions were carried out under positive pressure of argon. Glassware, syringes and needles were oven dried at 110° C., assembled while hot and dried under flow of dry nitrogen. Thin layer chromatography (TLC) was performed using glass precoated TLC plates (silica gel 60 F254). Flash chromatography was performed using Silica Gel 60, particle size range between 0.040-0.063 mm (230-400 Mesh). Additional visualization methods were also employed. TLC plates were developed with vanillin, iodine or ninhydrin. Typical solvents used for flash chromatography or think layer chromatography were mixtures of hexanes/ethyl acetate and dichoromethane/methanol. Compounds are named either manually or by using ChemDraw, or using their catalog name if commercially available.

### Exemplary Compounds of Structure I.

General Procedure for the Preparation of Cyclic and/or Chiral (Cyclic and/or Acyclic) Borates

### Synthesis of 2-methoxy-4,4,5,5-tetramethyl[1,3,2]dioxaborolane

A flask equipped with a reflux condenser, stirrer, an inert gas inlet and a thermocouple set in heating mantle was charged with trimethyl borate and pinacol under positive pressure of nitrogen. The resulting mixture was heated at reflux for 6 hours. The mixture was cooled to ambient temperatures and transferred to a flask with a Vigreux column. The mixture was distilled at atmospheric pressure to afford 2-methoxy-4,4,5,5-tetramethyl[1,3,2]dioxaborolane (bp 159° C.) in high yield (90%). ¹H NMR (400 MHz, CDCl₃): δ□ 3.41 (m, 3H), 1.11 (m, 12H). ¹¹B NMR (128.3 MHz, CDCl₃): δ 22.2. ¹³C NMR (100.6 MHz, CDCl₃): δ□ 82.7, 52.6, 24.6.

### 2-isopropoxy-4,4,5,5-tetramethyl[1,3,2]dioxaborolane

¹H NMR (400 MHz, CDCl₃): δ□ 4.24 (m, 1H), 1.16 (s, 12H), 1.11 (d, J=6.0 Hz, 6H). ¹¹B NMR (128.3 MHz, CDCl₃): δ 21.6. ¹³C NMR (100.6 MHz, CDCl₃): δ 82.4, 67.4, 24.7, 24.5□.

### 2-isopropoxy-5,5-dimethyl-1,3,2-dioxaborinane

¹H NMR (400 MHz, CDCl₃): δ□ 4.25 (m, 1H), 3.54 (d, J=2.1 Hz, 4H) 1.06 (dd, J=6.0 Hz, J=2.6 Hz, 6H), 0.86 (d, J=2.2 Hz, 6H). ¹¹B NMR (128.3 MHz, CDCl₃): δ 17.4. ¹³C NMR (100.6 MHz, CDCl₃): δ□ 73.0, 65.3, 32.0, 24.5, 21.7.

### 2-methoxy-5,5-dimethyl-1,3,2-dioxaborinane

¹H NMR (400 MHz, CDCl₃): δ□ 3.58 (s, 4H), 3.46 (s, 3H), 0.91 (s, 6H). ¹¹B NMR (128.3 MHz, CDCl₃): δ 17.7. ¹³C NMR (100.6 MHz, CDCl₃): δ□ 73.1, 51.2, 32.1, 21.7.

### 2-methoxy-4,4,6-trimethyl-1,3,2-dioxaborinane

¹H NMR (400 MHz, CDCl₃): δ□ 4.61-4.53 (m, 1H), 3.84 (s, 3H), 2.08 (dd, J=14.2 Hz, J=2.8 Hz, 1H), 1.82-1.76 (m, 1H), 1.62 (d, J=4.9 Hz, 6H), 1.58 (d, J=5.9 Hz, 3H). ¹¹B NMR (128.3 MHz, CDCl₃): δ 18.0. ¹³C NMR (100.6 MHz, CDCl₃): δ□ 72.0, 65.9, 51.1, 46.0, 31.4, 28.0, 23.3.

### 2-isopropoxy-4,4,6-trimethyl-1,3,2-dioxaborinane

¹H NMR (400 MHz, CDCl₃): δ□ 4.34-4.24 (m, 1H), 4.22-4.14 (m, 1H), 1.69 (dd, J=14.1 Hz, J=2.8 Hz, 1H), 1.41 (t, J=12.1 Hz), 1.23 (d, J=2.8 Hz, 6H), 1.19 (d, J=6.1 Hz, 3H), 1.11 (d, J=5.7 Hz, 3H). ¹¹B NMR (128.3 MHz, CDCl₃): δ 17.6. ¹³C NMR (100.6 MHz, CDCl₃): δ 71.8, 66.8, 65.1, 46.0, 31.4, 28.0, 24.5, 23.4□.

### 2-isopropoxy-1,3,2-dioxaborinane

¹H NMR (400 MHz, CDCl₃): δ□ 4.23 (q, J=6.7 Hz, 1H), 3.94-3.91 (m, 4H), 1.84-1.78 (m, 2H), 1.08-1.04 (m, 6H). ¹¹B NMR (128.3 MHz, CDCl₃): δ 17.6. ¹³C NMR (100.6 MHz, CDCl₃): δ 65.1, 62.8, 27.5, 24.5.

### Isopropyl bis(2-isopropyl-5-methylcyclohexyl)borate

¹H NMR (400 MHz, CDCl₃): δ□ 4.36 (m, 1H), 3.91-3.85 (m, 3H), 2.10-1.98 (m, 3H), 1.92-1.84 (m, 3H), 1.70-1.57 (m, 6H), 1.50-1.37 (m, 3H), 1.18-1.12 (m, 6H), 0.97-0.73 (m, 25H). ¹¹B NMR (128.3 MHz, CDCl₃): δ 17.7. ¹³C NMR (100.6 MHz, CDCl₃): δ 71.81, 71.76, 64.92, 64.90, 49.3, 49.2, 44.3, 44.2, 34.92, 34.91, 31.8, 26.0, 25.9, 24.7, 23.23, 23.17, 22.6, 22.5, 21.5, 21.4, 16.2, 16.1.

### (3aR,8aR)-6-isopropoxy-2,2-dimethyl-4,4,8,8-tetraphenyltetrahydro-[1,3]dioxolo[4,5-e][1,3,2]dioxaborepine

¹H NMR (400 MHz, CDCl₃): δ□ 7.65-7.22 (m, 20H), 4.64-4.55 (m, 1H), 3.92 (s, 1H), 1.33 (d, J=6.0 Hz, 3H), 1.18 (d, J=6.0 Hz, 3H), 0.99 (s, 6H). ¹¹B NMR (128.3 MHz, CDCl₃): δ 18.1. ¹³C NMR (100.6 MHz, CDCl₃): δ□ 146.3, 141.7, 128.9, 128.7, 128.4, 128.2, 127.9, 127.8, 127.7, 127.6, 127.5, 111.2, 82.5, 81.2, 79.6, 66.4, 27.2, 24.7.

### Synthesis of tris(2-isopropyl-5-methylcyclohexyl) borate

A flask equipped with a reflux condenser, stirrer, an inert gas inlet and a thermowell was charged with boric acid (1 equiv.), L-menthol (or D-menthol) (3 equiv.) and toluene under positive pressure of nitrogen. The resulting suspension was heated at reflux for 12 hours. The reaction was cooled to room temperature and precipitated white solid was filtered off. Yield 98%, MP=148-154° C. ¹H NMR (400 MHz, CDCl₃): δ□ 3.84 (td, J=10.4 Hz, J=4.4 Hz, 1H), 2.05-1.96 (m, 1H), 1.88-1.81 (m, 1H), 1.67-1.55 (m, 2H), 1.47-1.36 (m, 2H), 1.21-1.11 (m (1H), 1.02-0.80 (m, 8H), 0.72 (d, J=7.4 Hz, 3H). ¹¹B NMR (128.3 MHz, CDCl₃): δ 17.9. ¹³C NMR (100.6 MHz, CDCl₃): δ 71.7, 49.1, 44.2, 34.9, 31.7, 25.9, 23.1, 22.6, 21.5, 16.10.

### Synthesis of 2-isopropoxy-3a,5,5-trimethylhexahydro-4,6-methanobenzo[d][1,3,2]dioxaborole

To a stirred at 0° C. solution of (1S,2S,3R,5S)-(+)-pinanediol (or (1R,2R,3S,5R)-(−) pinanediol) in dichloromethane, triisopropylborate (1 equiv.) was added and then the reaction was allowed to warm up to room temperature overnight. The reaction was concentrated under reduced pressure to obtain the product as clear oil in quantitative yield. For (1S,2S,3R,5S)-(+)-pinanediol derivative in chloroform [□_{D}]²⁰_{c=0.1}=−18.16, ¹H NMR (400 MHz, CDCl₃): δ□ 4.36-4.29 (m, 1H), 4.25-4.23 (m, 1H), 2.34-2.26 (m, 1H), 2.25-2.18 (m, 1H), 2.03-1.99 (m, 1H), 1.92-1.82 (m, 2H), 1.39-1.36 (m, 4H), 1.26 (s, 3H), 1.19 (d, J=6.3 Hz, 6H), 0.81 (s, 3H). ¹¹B NMR (128.3 MHz, CDCl₃): δ 22.0. ¹³C NMR (100.6 MHz, CDCl₃): δ 84.4, 77.2, 67.7, 51.8, 39.7, 38.5, 36.0, 28.8, 27.3, 26.6, 24.6, 24.5, 24.20. For (1R,2R,3S,5R)-(−)-pinanediol derivative in chloroform [□_{D}]²⁰_{c=0.1}=19.44.

### Synthesis of diethyl 2-isopropoxy-1,3,2-dioxaborolane-4,5-dicarboxylate

A flask equipped with a reflux condenser, stirrer, an inert gas inlet and a thermocouple set in a heating mantle was charged with triisopropyl borate, (L)+diethyl tartrate and toluene under positive pressure of nitrogen. The reaction was heated up till reflux for 12 hours. The reaction was cooled to room temperature and the solvent was removed under reduced pressure in order to obtain the product. ¹H NMR (400 MHz, CDCl₃): δ□ 4.74 (s, 2H), 4.50-4.40 (m, 1H), 4.24 (q, J=7.2 Hz, 4H), 1.30-1.20 (m, 12H). ¹¹B NMR (128.3 MHz, CDCl₃): δ 22.5. ¹³C NMR (100.6 MHz, CDCl₃): δ□ 169.9, 76.5, 69.1, 62.3, 24.3, 14.3.

### Dimethyl 2-isopropoxy-1,3,2-dioxaborolane-4,5-dicarboxylate

¹H NMR (400 MHz, CDCl₃): δ□ 4.80 (s, 2H), 4.49-4.39 (m, 1H), 3.80 (s, 6H), 1.27-1.18 (m, 6H). ¹¹B NMR (128.3 MHz, CDCl₃): δ22.7. ¹³C NMR (100.6 MHz, CDCl₃): δ□ 170.3, 76.4, 69.2, 53.2, 24.4, 24.3.

### Exemplary Compounds of Structure II.

### Synthesis of 1,3-bis((1,3,2-dioxaborinan-2-yl)oxy)propane

A flask equipped with a reflux condenser with Dean-Stark apparatus, stirrer, an inert gas inlet and a thermocouple set in a heating mantle was charged with boric acid, 1,3-propanediol and toluene under positive pressure of nitrogen. The resulting suspension was heated at reflux till required amount of water was taken off the reaction. After cooling the reaction, the excess of the solvent was removed under reduced pressure in order to obtain the product in 93% yield. ¹H NMR (400 MHz, CDCl₃): δ□ 3.90 (m, 4H), 3.72 (m, 2H), 1.78 (m, 2H), 1.64 (m, 1H). ¹¹B NMR (128.3 MHz, CDCl₃): δ 17.8. ¹³C NMR (100.6 MHz, CDCl₃): δ□ 62.8, 59.9, 33.4, 27.4.

### 2,2′-oxybis(4,4,6-trimethyl-1,3,2-dioxaborinane

¹H NMR (400 MHz, CDCl₃): δ□ 4.20-4.12 (m, 1H), 1.64 (d, J=14.4 Hz, 1H), 1.38 (t, J=11.3 Hz, 1H), 1.18 (m, 6H), 1.16-1.13 (m, 3H). ¹¹B NMR (128.3 MHz, CDCl₃): δ 17.1. ¹³C NMR (100.6 MHz, CDCl₃): δ 72.0, 66.0, 45.7, 31.2, 27.9, 23.2□.

### General Procedure for the Synthesis of Cyclic Boronic Acid Esters Via Grignard Reagents and Cyclic Borates

### Synthesis of 4,4,6-trimethyl-2-phenyl-[1,3,2]dioxaborinane

To a solution of 2-isopropoxy-4,4,6-trimethyl-[1,3,2]dioxaborinane (5.58 g, 30 mmol, 1.5 eq.) in dry THF (15 ml) under an argon atmosphere a solution of phenylmagnesium bromide (1M in THF, 20 mmol) was added dropwise via addition funnel at room temperature. The reaction mixture was allowed to stir at ambient temperature for 2 hours. The reaction flask was then cooled to 0° C. and an aqueous solution of hydrochloric acid (1N, 30 ml) was added dropwise. After the addition was completed the reaction mixture was allowed to warm to ambient temperature for 1 hour. The organic layer was then separated from water layer. The latter one was extracted with ethyl acetate (3×30 ml). The combined organic layers were dried using magnesium sulfate, then filtered and concentrated under reduced pressure. The residue was purified using flash chromatography on silica gel (5% ethyl acetate:hexanes) to obtain the title compound in 98% yield. ¹H NMR (400 MHz, CDCl₃): δ□ 7.84 (d, J=7.3 Hz, 2H), 7.40 (t, J=7.3 Hz, 1H), 7.36 (t, J=7.9 Hz, 2H), 4.36 (m, 1H), 1.87 (dd, J=13.9 Hz, J=3.3 Hz, 1H), 1.62 (t, J=11.7 Hz, 1H), 1.41 (d, J=6.5 Hz, 6H), 1.38 (d, J=7.4 Hz, 3H). ¹¹B NMR (128.3 MHz, CDCl₃): δ 26.8. ¹³C NMR (100.6 MHz, CDCl₃): δ□ 133.6, 130.2, 127.3, 70.8, 64.9, 45.9, 31.2, 28.1, 23.1.

### 5,5-dimethyl-2-phenyl-1,3,2-dioxaborinane

Yield 93%. ¹H NMR (400 MHz, CDCl₃): δ□ 7.83 (m, 2H), 7.45 (m, 1H), 7.38 (m, 2H), 3.79 (s, 4H), 1.04 (s, 6H). ¹¹B NMR (128.3 MHz, CDCl₃): δ 26.7. ¹³C NMR (100.6 MHz, CDCl₃): δ□ 134.1, 130.9, 127.8, 72.5, 32.0, 22.2.

### 4,4,5,5-tetramethyl-2-phenyl-1,3,2-dioxaborolane

Yield 95%. ¹H NMR (400 MHz, CDCl₃): δ□ 7.85 (d, J=6.8 Hz, 2H), 7.48 (t, J=8.3 Hz, 1H), 7.39 (t, J=6.5 Hz, 2H), 1.37 (s, 12H). ¹¹B NMR (128.3 MHz, CDCl₃): δ 30.8. ¹³C NMR (100.6 MHz, CDCl₃): δ 135.0, 131.5, 128.0, 83.9, 25.1□.

### 2-isopropyl-5,5-dimethyl-1,3,2-dioxaborinane

Yield 55%. ¹H NMR (400 MHz, CDCl₃): δ□ 3.60 (s, 4H), 2.60 (m, 1H), 0.93 (m, 12H). ¹¹B NMR (128.3 MHz, CDCl₃): δ 30.6. ¹³C NMR (100.6 MHz, CDCl₃): δ□ 72.2, 31.8, 21.9, 18.4.

### 2-isobutyl-5,5-dimethyl-1,3,2-dioxaborinane

Yield 66%. ¹H NMR (400 MHz, CDCl₃): δ□ 3.58 (s, 4H), 1.80 (m, 1H), 0.95 (s, 6H), 0.90 (d, J=6.3 Hz, 6H), 0.65 (d, J=7.4 Hz, 2H). ¹¹B NMR (128.3 MHz, CDCl₃): δ 29.9. ¹³C NMR (100.6 MHz, CDCl₃): δ 72.1, 31.8, 25.6, 25.0, 22.1□.

### 2-isobutyl-4,4,5,5-tetramethyl-1,3,2-dioxaborolane

Yield 84%. ¹H NMR (400 MHz, CDCl₃): δ□ 1.84 (m, 1H), 1.23 (s, 12H), 0.91 (d, J=6.9 Hz, 6H), 0.71 (d, J=7.4 Hz, 2H). ¹¹B NMR (128.3 MHz, CDCl₃): δ 33.6. ¹³C NMR (100.6 MHz, CDCl₃): δ 83.0, 25.4, 25.1, 25.0□.

### 2-phenyl-1,3,2-dioxaborinane

Yield 71%. ¹H NMR (400 MHz, CDCl₃): δ□ 7.89-7.85 (m, 2H), 7.52-7.39 (m, 3H), 4.19 (t, J=5.7 Hz, 4H), 2.06 (q, J=5.6 Hz, 2H). ¹¹B NMR (128.3 MHz, CDCl₃): δ 26.8. ¹³C NMR (100.6 MHz, CDCl₃): δ0134.0, 130.9, 130.0, 127.9, 62.3, 27.7.

### 2-isobutyl-4,4,6-trimethyl-1,3,2-dioxaborinane

Yield 96%. ¹H NMR (400 MHz, CDCl₃): δ□ 4.16 (m, 1H), 1.79 (m, 2H), 1.43 (m, 1H), 1.26 (s, 6H), 1.23 (d, J=6.2 Hz, 3H), 0.88 (d, J=6.2 Hz, 6H), 0.59 (d, J=7.4 Hz, 2H). ¹¹B NMR (128.3 MHz, CDCl₃): δ 29.9. ¹³C NMR (100.6 MHz, CDCl₃): δ 70.6, 64.6, 46.2, 31.6, 28.3, 25.5, 25.4, 25.2, 23.5□.

### 2-isopropyl-4,4,6-trimethyl-1,3,2-dioxaborinane

Yield 67%. ¹H NMR (400 MHz, CDCl₃): δ□ 4.13 (m, 1H), 1.73 (dd, J=13.9 Hz, J=2.7 Hz, 1H), 1.40 (s, 6H), 1.22 (d, J=6.6 Hz, 3H), 0.89 (s, 6H). ¹¹B NMR (128.3 MHz, CDCl₃): δ 30.5. ¹³C NMR (100.6 MHz, CDCl₃): δ□ 70.1, 64.5, 46.2, 31.5, 20.3, 23.5, 18.6.

### 2-isopropyl-4,4,5,5-tetramethyl-1,3,2-dioxaborolane

Yield 42%. ¹H NMR (400 MHz, CDCl₃): δ□ 1.22 (s, 6H), 1.21 (s, 6H), 0.97 (s, 3H), 0.95 (s, 3H). ¹¹B NMR (128.3 MHz, CDCl₃): δ 34.4. ¹³C NMR (100.6 MHz, CDCl₃): δ□ 83.0, 24.9, 18.2.

### 2-allyl-4,4,5,5-tetramethyl-1,3,2-dioxaborolane

Yield 74%. ¹H NMR (400 MHz, CDCl₃): δ□ 5.83 (m, 1H), 5.00 (d, J=17.1 Hz, 1H), 4.90 (d, J=9.9 Hz, 1H), 1.70 (d, J=8.6 Hz, 2H), 1.22 (s, 12H). ¹¹B NMR (128.3 MHz, CDCl₃): δ 32.7. ¹³C NMR (100.6 MHz, CDCl₃): δ□ 134.3, 115.1, 83.5, 25.0.

### 2-allyl-4,4,6-trimethyl-1,3,2-dioxaborinane

Yield 46%. ¹H NMR (400 MHz, CDCl₃): δ□ 5.87 (m, 1H), 4.93 (d, J=17.5 Hz, 1H), 4.85 (d, J=9.8 Hz, 1H), 4.16 (m, 1H), 1.77 (d, J=2.8 Hz, 1H), 1.74 (d, J=2.8 Hz, 1H), 1.46 (m, 1H), 1.26 (s, 6H), 1.23 (d, J=6.0 Hz, 3H). ¹¹B NMR (128.3 MHz, CDCl₃): δ 29.0. ¹³C NMR (100.6 MHz, CDCl₃): δ□ 136.3, 113.7, 71.0, 65.0, 46.1, 31.4, 28.3, 23.3.

### 2-allyl-5,5-dimethyl-1,3,2-dioxaborinane

Yield 46%. ¹H NMR (400 MHz, CDCl₃): δ□ 5.86 (m, 1H), 4.95 (d, J=16.5 Hz, 1H), 4.90 (d, J=10.2 Hz, 1H), 3.59 (s, 4H), 1.67 (d, J=7.9 Hz, 2H), 0.95 (s, 6H). ¹¹B NMR (128.3 MHz, CDCl₃): δ 29.1. ¹³C NMR (100.6 MHz, CDCl₃): δ□ 135.6, 114.3, 72.4, 31.8, 22.0.

### 2-benzyl-4,4,6-trimethyl-1,3,2-dioxaborinane

Yield 64%. ¹H NMR (400 MHz, CDCl₃): δ□ 7.41-7.18 (m, 5H), 4.31 (m, 1H), 2.31 (s, 2H), 1.85-1.80 (m, 1H), 1.58-1.52 (m, 1H), 1.39-1.35 (m, 6H), 1.34-1.32 (m 3H). ¹¹B NMR (128.3 MHz, CDCl₃): δ 28.5. ¹³C NMR (100.6 MHz, CDCl₃): δ□ 140.7, 129.4, 128.8, 128.7, 126.2, 124.7, 71.5, 65.2, 46.2, 38.3, 31.6, 28.4, 23.5.

### 2-benzyl-5,5-dimethyl-1,3,2-dioxaborinane

Yield 64%. ¹H NMR (400 MHz, CDCl₃): δ□ 7.40-7.16 (m, 5H), 3.66 (s, 4H), 2.31 (s, 2H), 1.00 (s, 6H). ¹¹B NMR (128.3 MHz, CDCl₃): δ 28.9. ¹³C NMR (100.6 MHz, CDCl₃): δ□ 140.2, 129.2, 128.8, 128.5, 126.2, 124.9, 72.5, 38.3, 31.6, 22.1.

### 2-benzyl-4,4,5,5-tetramethyl-1,3,2-dioxaborolane

Yield 63%. ¹H NMR (400 MHz, CDCl₃): δ□ 7.29-7.13 (m, 5H), 2.33 (s, 2H), 1.27 (s, 12H). ¹¹B NMR (128.3 MHz, CDCl₃): δ 33.2. ¹³C NMR (100.6 MHz, CDCl₃): δ□ 138.9, 129.3, 128.5, 125.1, 83.7, 38.6, 25.0.

### 3a,5,5-trimethyl-2-phenylhexahydro-4,6-methanobenzo[d][1,3,2]dioxaborole

Yield 78%. ¹H NMR (400 MHz, CDCl₃): δ□ 7.86-7.83 (m, 2H), 7.50-7.37 (m, 3H), 4.48 (d, J=7.1 Hz, 1H), 2.47-2.40 (m, 1H), 2.28-2.16 (m, 2H), 2.02-1.94 (m, 2H), 1.50 (s, 3H), 1.33 (s, 3H), 1.24 (d, J=11.9 Hz, 1H), 0.91 (s, 3H). ¹¹B NMR (128.3 MHz, CDCl₃): δ 30.6. ¹³C NMR (100.6 MHz, CDCl₃): δ 135.0, 131.5, 128.0, 127.2, 86.5, 78.5, 51.6, 39.8, 38.5, 35.9, 29.0, 27.4, 26.8, 24.4, 24.3□.

### General Procedure for the Synthesis of Cyclic Boronic Acid Esters Via Grignard Reagents and Biborates

### Synthesis of 2-isobutyl-4-methyl-1,3,2-dioxaborinane

To a solution of 2,2′-oxybis(4-methyl)-1,3,2-dioxaborinane (3.21 g, 15 mmol, 0.75 equiv.) in dry THF (15 ml) under an argon atmosphere a solution of isobutylmagnesium bromide (2M in THF, 20 mmol, 10 ml) was added dropwise via addition funnel at room temperature. The reaction mixture was allowed to stir at ambient temperature for 2 hours. The reaction flask was then cooled to 0° C. and an aqueous solution of saturated ammonium chloride (30 ml) was added dropwise. After the addition was completed the reaction mixture was allowed to warm to ambient temperature for 1 hour. The organic layer was then separated from water layer. The latter one was extracted with ethyl acetate (3×30 ml). The combined organic layers were dried using magnesium sulfate, then filtered and concentrated under reduced pressure. The residue was purified using flash chromatography on silica gel (5% ethyl acetate:hexanes) to obtain the title compound in 57% yield. ¹H NMR (400 MHz, CDCl₃): δ□ 4.12-4.04 (m, 1H), 4.02-3.88 (m, 2H), 1.91-1.85 (m, 1H), 1.81-1.72 (m, 1H), 1.68-1.58 (m, 1H), 1.24 (d, J=6.8 Hz, 3H), 0.87 (d, J=6.1 Hz, 6H), 0.60 (d, J=8.1 Hz, 2H). ¹¹B NMR (128.3 MHz, CDCl₃): δ 30.5. ¹³C NMR (100.6 MHz, CDCl₃): δ 67.3, 61.0, 34.5, 25.5, 25.4, 25.0, 23.2□.

### General Procedure for the Synthesis of Cyclic Boronic Acid Esters Via Organolithium Reagents

### Synthesis of N-[4-Chloro-2-(4,4,6-trimethyl-[1,3,2]dioxaborinan-2-yl)-phenyl]-2,2-dimethyl-propionamide

To a solution of N-(4-chloro-phenyl)-2,2-dimethyl-propionamide (2.11 g, 10 mmol) in dry THF, n-butyl lithium solution was added dropwise (13 ml, 2.1 eq., 1.6 M in hexanes) under an argon atmosphere at −40° C. The reaction mixture was stirred for 2 hours at 0° C. during which time a white precipitate formed. The suspension was cooled to −20° C. and neat 2-isopropoxy-4,4,6-trimethyl-[1,3,2]dioxaborinane (2.8 g, 15 mmol, 1.5 eq.) was added dropwise. After stirring for 1 hour at this temperature, the reaction mixture was allowed to warm up to 0° C. and subsequently quenched with an aqueous solution of ammonium chloride (30 ml). The layers were then separated and the water layer was further extracted with dichloromethane (3×30 ml). The combined organic layers were dried over anhydrous sodium sulfate, filtered, and evaporated under reduced pressure. The crude residue was purified using flash chromatography on silica gel (15% ethyl acetate:hexanes) to obtain the title compound in good yield (74%). ¹H NMR (400 MHz, CDCl₃): δ□ 9.62 (s, 1H), 8.50 (d, J=9.2 Hz, 1H), 7.73 (d, J=2.5 Hz, 1H), 7.26 (dd, J=8.8 Hz, J=2.7 Hz, 1H), 4.39 (m, 1H), 1.87 (dd, J=13.5 Hz, J=2.9 Hz, 1H), 1.63 (t, J=2.5 Hz, 1H), 1.40 (d, J=10.7 Hz, 6H), 1.36 (d, J=6.7 Hz, 3H), 1.29 (s, 9H). ¹¹B NMR (128.3 MHz, CDCl₃): δ 26.2. ¹³C NMR (100.6 MHz, CDCl₃): δ□ 177.0, 143.1, 134.9, 131.1, 127.3, 120.5, 75.5, 65.8, 45.5, 39.6, 31.1, 28.0, 27.5, 23.0.

### N-(4-chloro-2-(4,4,5,5-tetramethyl-1,3,2-dioxaborolan-2-yl)phenyl)pivalamide

Yield 64%. ¹H NMR (400 MHz, CDCl₃): δ□ 9.51 (s, 1H), 8.49 (d, J=9.5 Hz, 1H), 7.73 (m, 1H), 7.37 (d, J=11.9Hz, 1H), 1.37 (s, 12H), 1.31 (s, 9H). ¹¹B NMR (128.3 MHz, CDCl₃): δ 29.1. ¹³C NMR (100.6 MHz, CDCl₃): δ□ 177.5, 143.6, 135.7, 132.7, 128.0, 120.8, 84.9, 77.3, 40.5, 27.8, 25.2.

### N-(4-(4,4,5,5-tetramethyl-1,3,2-dioxaborolan-2-yl)phenyl)pivalamide

Yield 91%. ¹H NMR (400 MHz, CDCl₃): δ□ 7.76 (d, J=8.6 Hz, 2H), 7.55 (d, J=8.6 Hz, 2H), 7.37 (s, 1H), 1.33 (s, 12H), 1.31 (s, 9H). ¹¹B NMR (128.3 MHz, CDCl₃): δ 31.1. ¹³C NMR (100.6 MHz, CDCl₃): δ□ 177.0, 141.0, 136.0, 118.9, 84.0, 40.0, 27.8, 25.1.

### N-(4-(4,4,6-trimethyl-1,3,2-dioxaborinan-2-yl)phenyl)pivalamide

Yield 89%. ¹H NMR (400 MHz, CDCl₃): δ□ 7.75 (d, J=8.6 Hz, 2H), 7.50 (d, J=8.6 Hz, 2H), 7.35 (s, 1H), 4.37-4.28 (m, 1H), 1.88-1.81 (m, 1H), 1.61-1.54 (m, 1H), 1.38-1.28 (m, 18H). ¹¹B NMR (128.3 MHz, CDCl₃): δ 26.9. ¹³C NMR (100.6 MHz, CDCl₃): δ□ 176.7, 140.1, 134.9, 118.7, 71.2, 65.2, 46.2, 40.1, 31.5, 28.4, 27.9, 23.5.

### N-(4-(5,5-dimethyl-1,3,2-dioxaborinan-2-yl)phenyl)pivalamide

Yield 58%. ¹H NMR (400 MHz, CDCl₃): δ□ 7.75 (d, J=8.5 Hz, 2H), 7.52 (d, J=8.5 Hz, 2H), 7.40 (s, 1H), 3.75 (s, 4H), 1.30 (s, 9H), 1.00 (s, 6H). ¹¹B NMR (128.3 MHz, CDCl₃): δ 22.5. ¹³C NMR (100.6 MHz, CDCl₃): δ□ 176.9, 140.5, 135.0, 122.7, 118.9, 115.9, 72.5, 39.9, 32.1, 27.9, 27.8, 22.2.

### General Procedure for Palladium Catalyzed Suzuki Coupling

### Synthesis of biphenyl-4-carbonitrile

Pd(OAc)₂ (2.3 mg, 1 mmol %), 4-bromo-benzonitrile (182 mg, 1.0 mmol), 4,4,6-trimethyl-2-phenyl-[1,3,2]dioxaborinane (224.4 mg, 1.1 mmol), Cs₂CO₃ (650 mg, 2 mmol), toluene (4 mL)-methanol (1 mL) were mixed together in a small reaction tube and the mixture was heated at 60° C. The reaction progress was followed by TLC (15% ethyl acetate:hexanes). After the starting materials were consumed the mixture was cooled and filtered through Celite followed by washing with toluene. The solvent was evaporated under reduced pressure and the residue was purified by flash chromatography on silica gel (15% ethyl acetate:hexanes) to obtain the title compound in excellent yield (95%). ¹H NMR (400 MHz, CDCl₃): δ□ 7.74-7.67 (m, 4H), 7.62-7.58 (m, 2H), 7.53-7.41 (m, 3H). ¹³C NMR (100.6 MHz, CDCl₃): δ□ 145.9, 139.4, 133.7, 132.9, 132.8, 129.4, 128.9, 128.0, 127.5, 119.2, 111.1.

### 1,2-diphenylethene

Yield 61%. ¹H NMR (400 MHz, CDCl₃): δ□ 7.39-7.25 (m, 8H), 7.11 (d, J=13.9 Hz, 1H), 6.70 (d, J=13.9 Hz, 1H). ¹³C NMR (100.6 MHz, CDCl₃): δ□ 137.4, 136.2, 129.0, 128.5, 126.3, 106.8.

### 2-phenylpyridine

Yield 71%. ¹H NMR (400 MHz, CDCl₃): δ□ 8.85 (s, 1H), 8.59 (d, J=4.1 Hz, 1H), 7.88 (d, J=8.2 Hz, 1H), 7.59 (d, J=10.9 Hz, 2H), 7.51-7.45 (m, 2H), 7.44-7.35 (m, 2H). ¹³C NMR (100.6 MHz, CDCl₃): δ□ 148.6, 148.4, 137.0, 129.3, 128.4, 127.4, 123.9.

### Exemplary Embodiments

1. A borate of the structure of Formula I

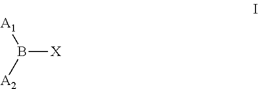

wherein A₁ and A₂ are independently selected from the group consisting of N—R, O—R, P—R and Si—R where R is selected independently from group consisting of optionally substituted alkyl, cycloalkyl, heterocycloalkyl, allyl, vinyl, aryl, benzyl, alkynyl, alkenyl, heteroaryl, trifluoromethyl, fluoroalkyl, acyl, amido and carboxyl, and
X is independently selected from the group consisting of O—R, N—R, P—R, Si—R where R is selected from the group consisting of optionally substituted alkyl, cycloalkyl, heterocycloalkyl, allyl, vinyl, aryl, benzyl, alkynyl, alkenyl, heteroaryl, trifluoromethyl, fluoroalkyl, acyl, amido and carboxyl.

2. A borate of the structure of Formula I

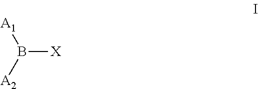

wherein A₁ and A₂ are joined together to form a carbocyclic, bicyclic, heterocyclic, aromatic or heteroaromatic ring with one or more R substituents where R is selected independently from the group consisting of optionally substituted alkyl, cycloalkyl, heterocycloalkyl, allyl, vinyl, aryl, benzyl, alkynyl, alkenyl, heteroaryl, trifluoromethyl, fluoroalkyl, acyl, amido and carboxyl, and
X is independently selected from the group consisting of O—R, N—R, P—R, Si—R where R is selected from the group consisting of optionally substituted alkyl, cycloalkyl, heterocycloalkyl, allyl, vinyl, aryl, benzyl, alkynyl, alkenyl, heteroaryl, trifluoromethyl, fluoroalkyl, acyl, amido and carboxyl.

3. A borate of the structure of Formula I

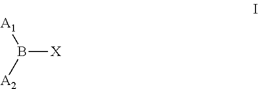

wherein A₁ and A₂ are joined to form a diol of the formula OH—R₁—R₂—OH, diamine of the formula RN—R₁—R₂—NR, or aminoalcohol of the formula RN—R₁—R₂—OH, and
X is independently selected from the group consisting of O—R, N—R, P—R, Si—R where R is selected from the group consisting of optionally substituted alkyl, cycloalkyl, heterocycloalkyl, allyl, vinyl, aryl, benzyl, alkynyl, alkenyl, heteroaryl, trifluoromethyl, fluoroalkyl, acyl, amido and carboxyl.

4. The borate of embodiment 3, wherein A₁ and A₂ are joined to form a 1,2-diol, 1,3-diol, 2,3-diol, 1,4-diol, 3,4-diol, 2,4-diol, 2,5-diol, 1,5-diol, 1,6-diol, 2,5-diol, 1,2-diamine, 1,3-diamine, 2,3-diamine, 1,4-diamine, 3,4-diamine, 2,4-diamine, 2,5-diamine, 1,5-diamine, 1,6-diamine, 2,5-diamine; 1,2-aminoalcohol, 1,3-aminoalcohol, 2,3-aminoalcohol, 1,4-aminoalcohol, 3,4-aminoalcohol, 2,4-aminoalcohol, 2,5-aminoalcohol, 1,5-aminoalcohol, 1,6-aminoalcohol, 2,5-aminoalcohol.

5. A borate of the structure of Formula I

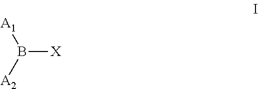

wherein A₁ and A₂ are joined together and represent a chiral bidentate ligand,
X is independently selected from the group consisting of O—R, N—R, P—R, Si—R where R is selected from the group consisting of optionally substituted alkyl, cycloalkyl, heterocycloalkyl, allyl, vinyl, aryl, benzyl, alkynyl, alkenyl, heteroaryl, trifluoromethyl, fluoroalkyl, acyl, amido and carboxyl, and
wherein the chiral bidentate ligand is derived from the group consisting of optionally protected carbohydrates, aminoalcohols, amino acids, alkaloids, aromatic or alkyl alcohols, aromatic or alkyl amines, diamines, diols, biaryl alcohols, biaryl amines, D- or L-tartaric acid or combinations thereof.

6. The borate of embodiment 5, wherein the joined group of A₁ and A₂ has diastereomeric and/or enantiomeric purity.

7. A borate of the structure of Formula I

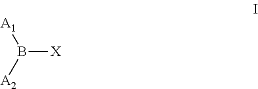

wherein A₁ and A₂ are joined to form a chiral diol of the formula OH—R₁—R₂—OH, chiral diamine of the formula RN—R₁—R₂—NR, or chiral aminoalcohol of the formula RN—R₁—R₂—OH, and
X is independently selected from the group consisting of O—R, N—R, P—R, Si—R where R is selected from the group consisting of optionally substituted alkyl, cycloalkyl, heterocycloalkyl, allyl, vinyl, aryl, benzyl, alkynyl, alkenyl, heteroaryl, trifluoromethyl, fluoroalkyl, acyl, amido and carboxyl.

8. The borate of embodiment 7, wherein the joined group of A₁ and A₂ has diastereomeric and/or enantiomeric purity.

9. The borate of embodiment 7, wherein R₁ and R₂ are, independently, selected from the group consisting of optionally substituted alkyl, cycloalkyl, heterocycloalkyl, allyl, vinyl, aryl, benzyl, alkynyl, alkenyl, heteroaryl, trifluoromethyl, fluoroalkyl, acyl, amido and carboxyl.

10. The borate of embodiment 7, wherein A₁ and A₂ are joined to form a group selected from 1,2-diols, 1,3-diols, 2,3-diols, 1,4-diols, 3,4-diols, 2,4-diols, 2,5-diols, 1,5-diols, 1,6-diols, 2,5-diols, 1,2-diamines, 1,3-diamines, 2,3-diamines, 1,4-diamines, 3,4-diamines, 2,4-diamines, 2,5-diamines, 1,5-diamines, 1,6-diamines, 2,5-diamines; 1,2-aminoalcohols, 1,3-aminoalcohols, 2,3-aminoalcohols, 1,4-aminoalcohols, 3,4-aminoalcohols, 2,4-aminoalcohols, 2,5-aminoalcohols, 1,5-aminoalcohols, 1,6-aminoalcohols, 2,5-aminoalcohols.

11. A biborate of the structure of Formula II

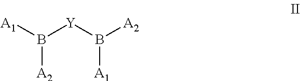

wherein A₁ and A₂ are independently selected from the group consisting of N—R, O—R, P—R and Si—R where R is selected independently from group consisting of optionally substituted alkyl, cycloalkyl, heterocycloalkyl, allyl, vinyl, aryl, benzyl, alkynyl, alkenyl, heteroaryl, trifluoromethyl, fluoroalkyl, acyl, amido and carboxyl, and
Y is independently selected from the group consisting N—R—N, O—R—O, P—R—P, Si—R—Si where R is selected from the group consisting of optionally substituted alkyl, cycloalkyl, heterocycloalkyl, allyl, vinyl, aryl, benzyl, alkynyl, alkenyl, heteroaryl, trifluoromethyl, fluoroalkyl, acyl, amido and carboxyl.

12. A biborate of the structure of Formula II

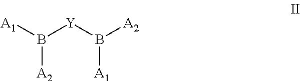

wherein A₁ and A₂ are joined together to form a carbocyclic, bicyclic, heterocyclic, aromatic or heteroaromatic ring with one or more R substituents where R is selected independently from the group consisting of optionally substituted alkyl, cycloalkyl, heterocycloalkyl, allyl, vinyl, aryl, benzyl, alkynyl, alkenyl, heteroaryl, trifluoromethyl, fluoroalkyl, acyl, amido and carboxyl, and
Y is independently selected from the group consisting N—R—N, O—R—O, P—R—P, Si—R—Si where R is selected from the group consisting of optionally substituted alkyl, cycloalkyl, heterocycloalkyl, allyl, vinyl, aryl, benzyl, alkynyl, alkenyl, heteroaryl, trifluoromethyl, fluoroalkyl, acyl, amido and carboxyl.

13. A biborate of the structure of Formula II

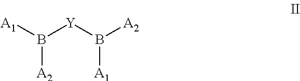

wherein A₁ and A₂ are joined to form a diol of the formula OH—R₁—R₂—OH, diamine of the formula RN—R₁—R₂—NR, or aminoalcohol of the formula RN—R₁—R₂—OH, and
Y is independently selected from the group consisting N—R—N, O—R—O, P—R—P, Si—R—Si where R is selected from the group consisting of optionally substituted alkyl, cycloalkyl, heterocycloalkyl, allyl, vinyl, aryl, benzyl, alkynyl, alkenyl, heteroaryl, trifluoromethyl, fluoroalkyl, acyl, amido and carboxyl.

14. The biborate of embodiment 13, wherein A₁ and A₂ are joined to form a 1,2-diol, 1,3-diol, 2,3-diol, 1,4-diol, 3,4-diol, 2,4-diol, 2,5-diol, 1,5-diol, 1,6-diol, 2,5-diol, 1,2-diamine, 1,3-diamine, 2,3-diamine, 1,4-diamine, 3,4-diamine, 2,4-diamine, 2,5-diamine, 1,5-diamine, 1,6-diamine, 2,5-diamine; 1,2-aminoalcohol, 1,3-aminoalcohol, 2,3-aminoalcohol, 1,4-aminoalcohol, 3,4-aminoalcohol, 2,4-aminoalcohol, 2,5-aminoalcohol, 1,5-aminoalcohol, 1,6-aminoalcohol, 2,5-aminoalcohol.

15. A biborate of the structure of Formula II

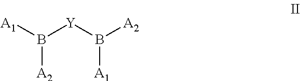

wherein A₁ and A₂ are joined together and represent a chiral bidentate ligand,
Y is independently selected from the group consisting N—R—N, O—R—O, P—R—P, Si—R—Si where R is selected from the group consisting of optionally substituted alkyl, cycloalkyl, heterocycloalkyl, allyl, vinyl, aryl, benzyl, alkynyl, alkenyl, heteroaryl, trifluoromethyl, fluoroalkyl, acyl, amido and carboxyl, and
wherein the chiral bidentate ligand is derived from the group consisting of optionally protected carbohydrates, aminoalcohols, amino acids, alkaloids, aromatic or alkyl alcohols, aromatic or alkyl amines, diamines, diols, biaryl alcohols, biaryl amines, D- or L-tartaric acid or combinations thereof.

16. The biborate of embodiment 15, wherein the joined group of A₁ and A₂ has diastereomeric and/or enantiomeric purity.

17. A biborate of the structure of II

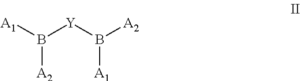

wherein A₁ and A₂ are joined to form a chiral diol of the formula OH—R₁—R₂—OH, chiral diamine of the formula RN—R₁—R₂—NR, or chiral aminoalcohol of the formula RN—R₁—R₂—OH.
Y is independently selected from the group consisting N—R—N, O—R—O, P—R—P, Si—R—Si where R is selected from the group consisting of optionally substituted alkyl, cycloalkyl, heterocycloalkyl, allyl, vinyl, aryl, benzyl, alkynyl, alkenyl, heteroaryl, trifluoromethyl, fluoroalkyl, acyl, amido and carboxyl.

18. The biborate of embodiment 17, wherein the joined group of A₁ and A₂ has diastereomeric and/or enantiomeric purity.

19. The biborate of embodiment 17, wherein R₁ and R₂ are, independently, selected from the group consisting of optionally substituted alkyl, cycloalkyl, heterocycloalkyl, allyl, vinyl, aryl, benzyl, alkynyl, alkenyl, heteroaryl, trifluoromethyl, fluoroalkyl, acyl, amido and carboxyl.

20. The biborate of embodiment 17, wherein A₁ and A₂ are joined to form a group selected from 1,2-diols, 1,3-diols, 2,3-diols, 1,4-diols, 3,4-diols, 2,4-diols, 2,5-diols, 1,5-diols, 1,6-diols, 2,5-diols, 1,2-diamines, 1,3-diamines, 2,3-diamines, 1,4-diamines, 3,4-diamines, 2,4-diamines, 2,5-diamines, 1,5-diamines, 1,6-diamines, 2,5-diamines; 1,2-aminoalcohols, 1,3-aminoalcohols, 2,3-aminoalcohols, 1,4-aminoalcohols, 3,4-aminoalcohols, 2,4-aminoalcohols, 2,5-aminoalcohols, 1,5-aminoalcohols, 1,6-aminoalcohols, 2,5-aminoalcohols.

21. A method of synthesis of boronates, the method comprising the following reaction scheme:

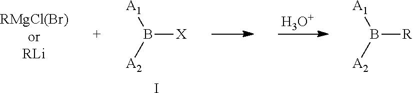

wherein R is selected independently from group consisting of optionally substituted alkyl, cycloalkyl, heterocycloalkyl, allyl, vinyl, aryl, benzyl, alkynyl, alkenyl, heteroaryl, trifluoromethyl, fluoroalkyl, acyl, amido and carboxyl;
A₁ and A₂ are independently selected from the group consisting of N—R, O—R, P—R and Si—R where R is selected independently from group consisting of optionally substituted alkyl, cycloalkyl, heterocycloalkyl, allyl, vinyl, aryl, benzyl, alkynyl, alkenyl, heteroaryl, trifluoromethyl, fluoroalkyl, acyl, amido and carboxyl; and
X is independently selected from the group consisting of O—R, N—R, P—R, Si—R where R is selected from the group consisting of optionally substituted alkyl, cycloalkyl, heterocycloalkyl, allyl, vinyl, aryl, benzyl, alkynyl, alkenyl, heteroaryl, trifluoromethyl, fluoroalkyl, acyl, amido and carboxyl.

22. The method of synthesis of embodiment 21, wherein compound I is selected from the borate of any of claims 1-10.

23. The method of synthesis of embodiment 21, wherein the method is conducted in the temperature range of 10-28° C.

24. The method of synthesis of embodiment 21, wherein the method is conducted in a medium of a polar and aprotic solvent or a mixture (in any ratio) of any nonpolar and aprotic solvent with polar and aprotic solvent.

25. The method of synthesis of embodiment 21, wherein the method is conducted in a medium of diethyl ether, tetrahydrofuran, or dioxane.

26. The method of synthesis of embodiment 21, wherein the reaction is quenched by adding an aqueous solution of inorganic or organic acid or aqueous solution of ammonium chloride.

27. A method of synthesis of boronates, the method comprising the following reaction scheme:

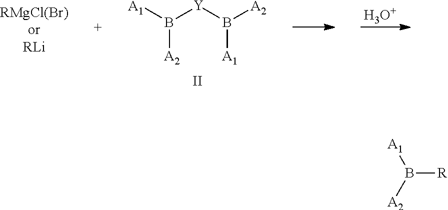

wherein R is selected independently from group consisting of optionally substituted alkyl, cycloalkyl, heterocycloalkyl, allyl, vinyl, aryl, benzyl, alkynyl, alkenyl, heteroaryl, trifluoromethyl, fluoroalkyl, acyl, amido and carboxyl;
A₁ and A₂ are independently selected from the group consisting of N—R, O—R, P—R and Si—R where R is selected independently from group consisting of optionally substituted alkyl, cycloalkyl, heterocycloalkyl, allyl, vinyl, aryl, benzyl, alkynyl, alkenyl, heteroaryl, trifluoromethyl, fluoroalkyl, acyl, amido and carboxyl; and
Y is independently selected from the group consisting N—R—N, O—R—O, P—R—P, Si—R—Si where R is selected from the group consisting of optionally substituted alkyl, cycloalkyl, heterocycloalkyl, allyl, vinyl, aryl, benzyl, alkynyl, alkenyl, heteroaryl, trifluoromethyl, fluoroalkyl, acyl, amido and carboxyl.

28. The method of synthesis of embodiment 27, wherein compound II is selected from the biborate of any of claims 11-20.

29. The method of synthesis of embodiment 27, wherein the method is conducted in the temperature range of 10-28° C.

30. The method of synthesis of embodiment 27, wherein the method is conducted in a medium of a polar and aprotic solvent or a mixture (in any ratio) of any nonpolar and aprotic solvent with polar and aprotic solvent.

31. The method of synthesis of embodiment 27, wherein the method is conducted in a medium of diethyl ether, tetrahydrofuran, or dioxane.

32. The method of synthesis of embodiment 27, wherein the reaction is quenched in situ by adding an aqueous solution of inorganic or organic acid or aqueous solution of ammonium chloride.

1. A borate of the structure of Formula I 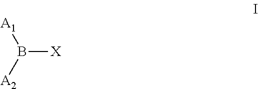
wherein A₁, A₂ and X are selected as described in one of the following:
A: wherein A₁ and A₂ are independently selected from the group consisting of N—R, O—R, P—R and Si—R where R is selected independently from group consisting of optionally substituted alkyl, cycloalkyl, heterocycloalkyl, allyl, vinyl, aryl, benzyl, alkynyl, alkenyl, heteroaryl, trifluoromethyl, fluoroalkyl, acyl, amido and carboxyl, and
X is independently selected from the group consisting of O—R, N—R, P—R, Si—R where R is selected from the group consisting of optionally substituted alkyl, cycloalkyl, heterocycloalkyl, allyl, vinyl, aryl, benzyl, alkynyl, alkenyl, heteroaryl, trifluoromethyl, fluoroalkyl, acyl, amido and carboxyl;
B: wherein A₁ and A₂ are joined together to form a carbocyclic, bicyclic, heterocyclic, aromatic or heteroaromatic ring with one or more R substituents where R is selected independently from the group consisting of optionally substituted alkyl, cycloalkyl, heterocycloalkyl, allyl, vinyl, aryl, benzyl, alkynyl, alkenyl, heteroaryl, trifluoromethyl, fluoroalkyl, acyl, amido and carboxyl, and
X is independently selected from the group consisting of O—R, N—R, P—R, Si—R where R is selected from the group consisting of optionally substituted alkyl, cycloalkyl, heterocycloalkyl, allyl, vinyl, aryl, benzyl, alkynyl, alkenyl, heteroaryl, trifluoromethyl, fluoroalkyl, acyl, amido and carboxyl;
C: wherein A₁ and A₂ are joined to form a diol of the formula OH—R₁—R₂—OH, diamine of the formula RN—R₁—R₂—NR, or aminoalcohol of the formula RN—R₁—R₂—OH, and
X is independently selected from the group consisting of O—R, N—R, P—R, Si—R where R is selected from the group consisting of optionally substituted alkyl, cycloalkyl, heterocycloalkyl, allyl, vinyl, aryl, benzyl, alkynyl, alkenyl, heteroaryl, trifluoromethyl, fluoroalkyl, acyl, amido and carboxyl;
D: wherein A₁ and A₂ are joined together and represent a chiral bidentate ligand,
X is independently selected from the group consisting of O—, N—R, P—R, Si—R where R is selected from the group consisting of optionally substituted alkyl, cycloalkyl, heterocycloalkyl, allyl, vinyl, aryl, benzyl, alkynyl, alkenyl, heteroaryl, trifluoromethyl, fluoroalkyl, acyl, amido and carboxyl, and
wherein the chiral bidentate ligand is derived from the group consisting of optionally protected carbohydrates, aminoalcohols, amino acids, alkaloids, aromatic or alkyl alcohols, aromatic or alkyl amines, diamines, diols, biaryl alcohols, biaryl amines, D- or L-tartaric acid or combinations thereof; and
E: wherein A₁ and A₂ are joined to form a chiral diol of the formula OH—R₁—R₂—OH, chiral diamine of the formula RN—R₁—R₂—NR, or chiral aminoalcohol of the formula RN—R₁—R₂—OH, and
X is independently selected from the group consisting of O—R, N—R, P—R, Si—R where R is selected from the group consisting of optionally substituted alkyl, cycloalkyl, heterocycloalkyl, allyl, vinyl, aryl, benzyl, alkynyl, alkenyl, heteroaryl, trifluoromethyl, fluoroalkyl, acyl, amido and carboxyl.

2. The borate of claim 1, wherein A₁, A₂ and X are selected as described in C or E, and wherein A₁ and A₂ are joined to form a group selected from 1,2-diols, 1,3-diols, 2,3-diols, 1,4-diols, 3,4-diols, 2,4-diols, 2,5-diols, 1,5-diols, 1,6-diols, 2,5-diols, 1,2-diamines, 1,3-diamines, 2,3-diamines, 1,4-diamines, 3,4-diamines, 2,4-diamines, 2,5-diamines, 1,5-diamines, 1,6-diamines, 2,5-diamines; 1,2-aminoalcohols, 1,3-aminoalcohols, 2,3-aminoalcohols, 1,4-aminoalcohols, 3,4-aminoalcohols, 2,4-aminoalcohols, 2,5-aminoalcohols, 1,5-aminoalcohols, 1,6-aminoalcohols, 2,5-aminoalcohols.

3. The borate of claim 1, wherein A₁, A₂ and X are selected as described in D or E, and wherein the joined group of A₁ and A₂ has diastereomeric and/or enantiomeric purity.

4. The borate of claim 1, wherein A₁, A₂ and X are selected as described in E, and wherein R₁ and R₂ are, independently, selected from the group consisting of optionally substituted alkyl, cycloalkyl, heterocycloalkyl, allyl, vinyl, aryl, benzyl, alkynyl, alkenyl, heteroaryl, trifluoromethyl, fluoroalkyl, acyl, amido and carboxyl.

5. A biborate of the structure of Formula II 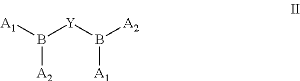
wherein A₁, A₂ and Y are selected as described in one of the following:
A: wherein A₁ and A₂ are independently selected from the group consisting of N—R, O—R, P—R and Si—R where R is selected independently from group consisting of optionally substituted alkyl, cycloalkyl, heterocycloalkyl, allyl, vinyl, aryl, benzyl, alkynyl, alkenyl, heteroaryl, trifluoromethyl, fluoroalkyl, acyl, amido and carboxyl, and
Y is independently selected from the group consisting N—R—N, O—R—O, P—R—P, Si—R—Si where R is selected from the group consisting of optionally substituted alkyl, cycloalkyl, heterocycloalkyl, allyl, vinyl, aryl, benzyl, alkynyl, alkenyl, heteroaryl, trifluoromethyl, fluoroalkyl, acyl, amido and carboxyl;
B: wherein A₁ and A₂ are joined together to form a carbocyclic, bicyclic, heterocyclic, aromatic or heteroaromatic ring with one or more R substituents where R is selected independently from the group consisting of optionally substituted alkyl, cycloalkyl, heterocycloalkyl, allyl, vinyl, aryl, benzyl, alkynyl, alkenyl, heteroaryl, trifluoromethyl, fluoroalkyl, acyl, amido and carboxyl, and
Y is independently selected from the group consisting N—R—N, O—R—O, P—R—P, Si—R—Si where R is selected from the group consisting of optionally substituted alkyl, cycloalkyl, heterocycloalkyl, allyl, vinyl, aryl, benzyl, alkynyl, alkenyl, heteroaryl, trifluoromethyl, fluoroalkyl, acyl, amido and carboxyl;
C: wherein A₁ and A₂ are joined to form a diol of the formula OH—R₁—R₂—OH, diamine of the formula RN—R₁—R₂—NR, or aminoalcohol of the formula RN—R₁—R₂—OH, and
Y is independently selected from the group consisting N—R—N, O—R—O, P—R—P, Si—R—Si where R is selected from the group consisting of optionally substituted alkyl, cycloalkyl, heterocycloalkyl, allyl, vinyl, aryl, benzyl, alkynyl, alkenyl, heteroaryl, trifluoromethyl, fluoroalkyl, acyl, amido and carboxyl;
D: wherein A₁ and A₂ are joined together and represent a chiral bidentate ligand,
Y is independently selected from the group consisting N—R—N, O—R—O, P—R—P, Si—R—Si where R is selected from the group consisting of optionally substituted alkyl, cycloalkyl, heterocycloalkyl, allyl, vinyl, aryl, benzyl, alkynyl, alkenyl, heteroaryl, trifluoromethyl, fluoroalkyl, acyl, amido and carboxyl, and
wherein the chiral bidentate ligand is derived from the group consisting of optionally protected carbohydrates, aminoalcohols, amino acids, alkaloids, aromatic or alkyl alcohols, aromatic or alkyl amines, diamines, diols, biaryl alcohols, biaryl amines, D- or L-tartaric acid or combinations thereof; and
E: wherein A₁ and A₂ are joined to form a chiral diol of the formula OH—R₁—R₂—OH, chiral diamine of the formula RN—R₁—R₂—NR, or chiral aminoalcohol of the formula RN—R₁—R₂—OH,
Y is independently selected from the group consisting N—R—N, O—R—O, P—R—P, Si—R—Si where R is selected from the group consisting of optionally substituted alkyl, cycloalkyl, heterocycloalkyl, allyl, vinyl, aryl, benzyl, alkynyl, alkenyl, heteroaryl, trifluoromethyl, fluoroalkyl, acyl, amido and carboxyl.

6. The biborate of claim 5, wherein A₁, A₂ and Y are selected as described in C or E, and wherein A₁ and A₂ are joined to form a group selected from 1,2-diol, 1,3-diol, 2,3-diol, 1,4-diol, 3,4-diol, 2,4-diol, 2,5-diol, 1,5-diol, 1,6-diol, 2,5-diol, 1,2-diamine, 1,3-diamine, 2,3-diamine, 1,4-diamine, 3,4-diamine, 2,4-diamine, 2,5-diamine, 1,5-diamine, 1,6-diamine, 2,5-diamine; 1,2-aminoalcohol, 1,3-aminoalcohol, 2,3-aminoalcohol, 1,4-aminoalcohol, 3,4-aminoalcohol, 2,4-aminoalcohol, 2,5-aminoalcohol, 1,5-aminoalcohol, 1,6-aminoalcohol, 2,5-aminoalcohol.

7. The biborate of claim 5, wherein A₁, A₂ and Y are selected as described in D or E, and wherein the joined group of A₁ and A₂ has diastereomeric and/or enantiomeric purity.

8. The biborate of claim 5, wherein A₁, A₂ and Y are selected as described in E, and wherein R₁ and R₂ are, independently, selected from the group consisting of optionally substituted alkyl, cycloalkyl, heterocycloalkyl, allyl, vinyl, aryl, benzyl, alkynyl, alkenyl, heteroaryl, trifluoromethyl, fluoroalkyl, acyl, amido and carboxyl.

9. A method of synthesis of boronates, the method comprising the following reaction scheme: 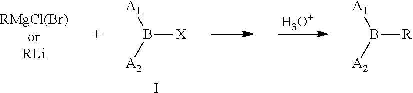
wherein R is selected independently from group consisting of optionally substituted alkyl, cycloalkyl, heterocycloalkyl, allyl, vinyl, aryl, benzyl, alkynyl, alkenyl, heteroaryl, trifluoromethyl, fluoroalkyl, acyl, amido and carboxyl;
A₁ and A₂ are independently selected from the group consisting of N—R, O—R, P—R and Si—R where R is selected independently from group consisting of optionally substituted alkyl, cycloalkyl, heterocycloalkyl, allyl, vinyl, aryl, benzyl, alkynyl, alkenyl, heteroaryl, trifluoromethyl, fluoroalkyl, acyl, amido and carboxyl; and
X is independently selected from the group consisting of O—R, N—R, P—R, Si—R where R is selected from the group consisting of optionally substituted alkyl, cycloalkyl, heterocycloalkyl, allyl, vinyl, aryl, benzyl, alkynyl, alkenyl, heteroaryl, trifluoromethyl, fluoroalkyl, acyl, amido and carboxyl.

10. The method of synthesis of claim 9, wherein compound I is selected from the borate of any of claims 1-10.

11. The method of synthesis of claim 9, wherein the method is conducted in the temperature range of 10-28° C.

12. The method of synthesis of claim 9, wherein the method is conducted in a medium of a polar and aprotic solvent or a mixture (in any ratio) of any nonpolar and aprotic solvent with polar and aprotic solvent.

13. The method of synthesis of claim 9, wherein the method is conducted in a medium of diethyl ether, tetrahydrofuran, or dioxane.

14. The method of synthesis of claim 9, wherein the reaction is quenched by adding an aqueous solution of inorganic or organic acid or aqueous solution of ammonium chloride.

15. A method of synthesis of boronates, the method comprising the following reaction scheme: 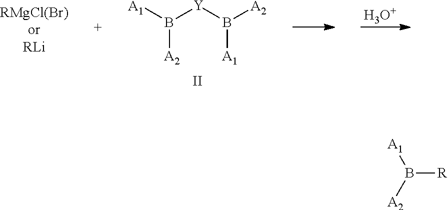
wherein R is selected independently from group consisting of optionally substituted alkyl, cycloalkyl, heterocycloalkyl, allyl, vinyl, aryl, benzyl, alkynyl, alkenyl, heteroaryl, trifluoromethyl, fluoroalkyl, acyl, amido and carboxyl; A₁ and A₂ are independently selected from the group consisting of N—R, O—R, P—R and Si—R where R is selected independently from group consisting of optionally substituted alkyl, cycloalkyl, heterocycloalkyl, allyl, vinyl, aryl, benzyl, alkynyl, alkenyl, heteroaryl, trifluoromethyl, fluoroalkyl, acyl, amido and carboxyl; and
Y is independently selected from the group consisting N—R—N, O—R—O, P—R—P, Si—R—Si where R is selected from the group consisting of optionally substituted alkyl, cycloalkyl, heterocycloalkyl, allyl, vinyl, aryl, benzyl, alkynyl, alkenyl, heteroaryl, trifluoromethyl, fluoroalkyl, acyl, amido and carboxyl.

16. The method of synthesis of claim 15, wherein compound II is selected from the biborate of any of claims 11-20.

17. The method of synthesis of claim 15, wherein the method is conducted in the temperature range of 10-28° C.

18. The method of synthesis of claim 15, wherein the method is conducted in a medium of a polar and aprotic solvent or a mixture (in any ratio) of any nonpolar and aprotic solvent with polar and aprotic solvent.

19. The method of synthesis of claim 15, wherein the method is conducted in a medium of diethyl ether, tetrahydrofuran, or dioxane.

20. The method of synthesis of claim 15, wherein the reaction is quenched in situ by adding an aqueous solution of inorganic or organic acid or aqueous solution of ammonium chloride.
